(19) United States
(12) Patent Application Publication
(10) Pub. No.: US 2026/0240322 A1
(43) Pub. Date: Aug. 20, 2026

(54) Storage System with Mechanical Safety Provision

(71) Applicant: Bruynzeel Storage Systems, Panningen (NL)

(72) Inventors: Johannes Maria Gerardus Joosten, Panningen (NL); Franciscus Matheus Marie Lommen, Panningen (NL)

(21) Appl. No.: 19/057,215

(22) Filed: Feb. 19, 2025

(51) Int. Cl. A47B 53/02; F16D 63/00

(52) U.S. Cl. CPC A47B 53/02; F16D 63/006

(57) ABSTRACT

The present invention relates to a storage system, comprising at least one cabinet, that is movable and in particular rollable with respect to a support surface, provided with a drive mechanism that extends via a transmission between a first engagement point for receiving a driving force or torque, to a second engagement point for exerting a driving force or torque on the surface, wherein the cabinet is provided with an emergency braking facility, with at least one activating member, which emergency braking facility is adapted to stop the cabinet to a standstill with a limited braking torque or with a limited braking force when the activating member is enabled.

The present invention relates to a storage system, in particular a storage system for archives, books or art storage, and more specific for the aforementioned purposes at an industrial scale, although other purposes are not excluded. A system of this type is for instance known from the European patent publication EP3970562 of the same applicant. In general, systems of this kind comprise a plurality of cabinets or shelving units that extend parallel to each other in a longitudinal direction and are each movable in a width direction, transverse to the longitudinal direction. This way, the position of each of the cabinets can be varied, or the interspace between two adjacent cabinets, or an aisle width and position between two adjacent cabinets. Especially the latter, changing the aisle width and position, is a beneficial property of this type of storage system. However, this aspect also requires safe operation of the system, and in particular means to prevent persons or objects to get stuck in between adjacent cabinets.

It is known to provide systems like this with a safety provision. Such provision may comprise an emergency braking facility, an activating member, which emergency braking facility is adapted to stop the cabinet to a standstill when the activating member is enabled. The emergency braking facilities according to the prior art have in common that they directly block the movement of the cabinet. Examples are U.S. Patent application US2004035811 or international patent application WO9802063. Although this is safe in the sense of limiting the distance the cabinet moves when an unsafe or dangerous situation is detected, to the means causing the driving force of such cabinet, which may for instance comprise a gear for manual driving or an electric drive system, an abrupt blocking may cause damage. It is therefore known to protect these driving means against the activation of the driving means, for instance by means of a slip clutch (also referred to as slip coupling or slipper coupling). Another disadvantage of an abrupt stop is that there is a risk of tilting of the cabinet and/or contents falling out of the shelving. This may cause harm to a person in the aisle and of course damage the cabinet and/or its contents.

US patent publication US2007252491A1 describes a solution wherein the kinetic energy of a moving cabinet is assimilated by a torsion absorbing coupling member, wherein a rubber disk sandwiched between two metal discs is applied for coming under a torsional stress during a brake. Although the publication states that energy is dissipated this way, it is in fact stored in the rubber part when that is wound up. The amount of rotation that is allowed between the metal discs is highly limited by the amount of torsion the rubber disc can store.

It is therefore a goal of the present invention to take away the disadvantages of the prior art and/or to propose a useful alternative to the prior art. In particular, it is a goal of the present invention to improve safety of the operation to such systems that are manually operated and driven. It is a goal of the present invention to improve safety of the operation of such system.

The invention thereto proposes a storage system, comprising at least one a mobile base for supporting shelving or rack or cabinet, that is movable and in particular rollable with respect to a support surface, provided with a drive mechanism that extends via a transmission between at least a first engagement point for receiving a driving force or torque, to at least a second engagement point for exerting a driving force or torque on the surface, wherein the cabinet is provided with an emergency braking facility, with at least one activating member, which emergency braking facility is adapted to stop the cabinet to a standstill with a limited braking torque or with a limited braking force when the activating member is enabled.

In general, the at least one cabinet according to the invention is oblong, and it extends in a length direction, while it is movable in a width direction, perpendicular to said length direction. In the remainder of this application, where a cabinet is mentioned, the terms shelving or rack implicitly meant too.

In its general form, the system according to the invention directly blocks a driving force exerted at the first engaging point. In those cases where the system is manually driven, this implies that a person moving the cabinet can no longer exert a driving force, that is: in the direction wherein he or she was driving a cabinet. Storage systems of the kind described here may be equipped with a manual operating element, such as a wheel or a handle at the first engagement point for manually driving the shelving unit driving wheel for manually driving the system, and the transmission at the height of the first engaging point may comprise a chain or a gear transmission. A manual drive system like this may comprise for instance a reduction gearbox, located between the blocking point and the first engagement point, for reducing the number of revolutions of a drive movement from the first engagement point to the blocking point. Such drive system is known in the art and makes it easier and lighter for an operating person to move a cabinet.

In particular, the invention also relates to a device according to claim 1.

To protect the operator of such systems, a slip clutch may be applied here too, to avoid injuries when the driving wheel is suddenly blocked. In a case wherein a powered machine force is used to drive the system, further features of the invention may protect the drive system from damage from being blocked. According to the prior art, a slip clutch may be used for this purpose, but more advanced solutions integrated in the control of the system are thinkable too. Such solutions may for instance comprise an over-current detection.

According to an embodiment of the system according to the invention however, the emergency braking facility is adapted to block the drive mechanism at a blocking point located between the first and the second engagement point, wherein a force or torque limiter, such as a slip clutch, is present between the blocking point and the second engagement point.

Such torque or force limiter has the benefit that unlike a torsion absorbing coupling member that is wound up during braking as disclosed in US2007252491A1, it is an element that does not limit the number of turns which can be made at the second engaging point once the emergency brake is activated. In other words, the emergency braking facility according to the invention is adapted to stop the cabinet to a standstill with a limited braking torque or with a limited braking force when the activating member is enabled, wherein this braking torque or force is essentially continuous during the braking path. When using a torsion absorbing coupling member, this force increases during braking, and since the energy is stored in the rubber disc, once stopped, the cabinet will tend to move in opposite direction, which is not safe and therefore not desired.

Contrary to the prior art, according to the invention the slip clutch is not used to set a maximum to the driving force on the drive mechanism or more in particular to the driving force on the transmission thereof. Instead, the drive mechanism and in particular the transmission thereof is completely blocked and the slip clutch is used to set maximum value to a braking power. In other words, the invention allows a certain distance significantly larger than zero to form a braking path for a cabinet. The system according to the invention may be dimensioned, adapted or configured such that a braking path of a cabinet is longer than 1.5 centimeters, preferably longer than 2 centimeters, and by further preference longer than 5 centimeters and up to 10 centimeters.

In a further embodiment, the force or torque limiter has an adjustable value for the force or torque to which it is limited. This adjustable value can be set during use or prior to use, and a threshold value may be determined by a set or measured weight of the shelving unit and/or a load thereof.

In a preferred embodiment, the activating member comprises a pressure sensor connected to the cabinet, for instance formed by or coupled to a plinth of said cabinet, comprising a cam or hook, adapted to engage in an enabled position on a slot, recess or teeth, arranged on or coupled to the transmission, for forming a blocking. In a further preferred embodiment, the cabinet is provided with at least two activating members, arranged on either side in width direction of the cabinet, each adapted to block the driving of the cabinet when the activating member is activated on their respective side. The two activating members may thus act on the same transmission, blocking an opposite direction of rotation.

To unlock a blocked system according to the invention, the emergency braking facility may be adapted to anchor the drive mechanism as long as it is not driven in an opposite direction to the direction in which it was blocked. Such provision ensures that an operator who has encountered a higher driving force is cannot simply continue to drive the system once the cause of the blockage that touched the emergency brake is removed and has to verify that the cause of the blocking is solved. This is also beneficial for a person that enabled the emergency braking system, who is then not directly hit again by the cabinet, after having stepped away from it.

The second engagement point may comprise a gear wheel adapted to engage on a chain arranged in or on the support surface. The chain may preferably be embedded in the support surface and thus have a fixed location with respect to said surface. The chain may form a common rail shared by multiple parallel cabinets. Unlike embodiments wherein cabinets engage their support surface with wheels, the coupling of a cabinet that engages such chain with a gear wheel, allows no slip in that coupling. In an aspect, the present invention thus relates to a system wherein the second engaging point comprises a slip-less coupling such as a coupling comprising a chain and a gear.

As described above, the storage systems of the kind described here may be equipped with a manual operating element, such as a wheel or a handle at the first engagement point for manually driving the shelving unit driving wheel for manually driving the system, and the transmission at the height of the first engaging point may comprise a chain or a gear transmission. According to the present invention, the manual operating system may comprise a transmission that comprises a combined chain and a gear transmission. The drive system according to the present invention may further comprise a force or torque limiter, such as a slip clutch arranged in said transmission for manually driving the shelving unit. The force or torque limiter, such as a slip clutch in the transmission for manually driving the shelving unit has a threshold torque above which it starts limiting or slipping, that is lower than a threshold torque of the force or torque limiter, such as a slip clutch, of the emergency braking facility.

The present invention also relates to a system comprising a plurality of shelving units that are movable relative to the support surface and in particular rollable, wherein the shelving units are movable over a common rail system.

The invention will now be elucidated with reference to the following figures. Herein:

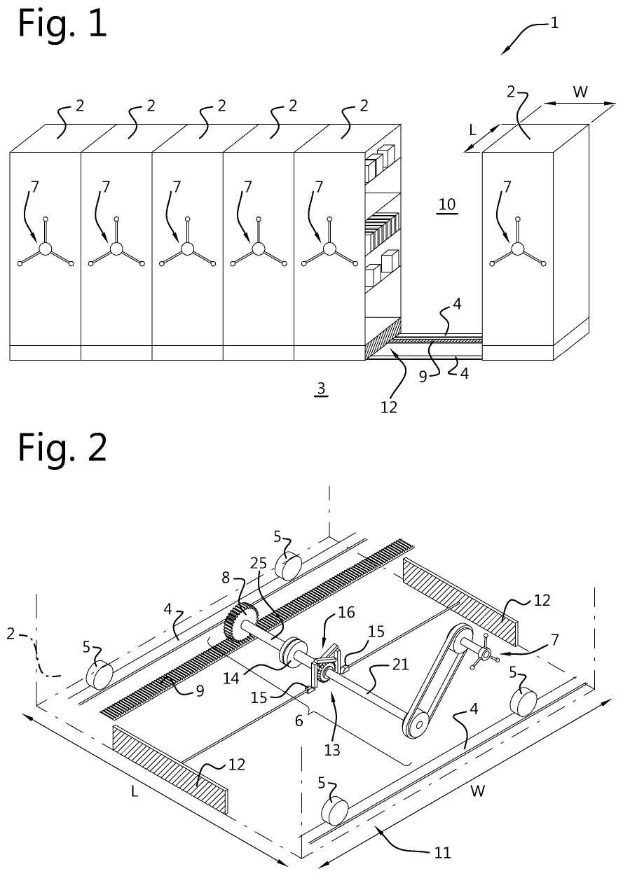

FIG. 1 shows a schematic overview of a system according to the invention;

FIG. 2 shows a schematic overview of an emergency braking facility according to the invention;

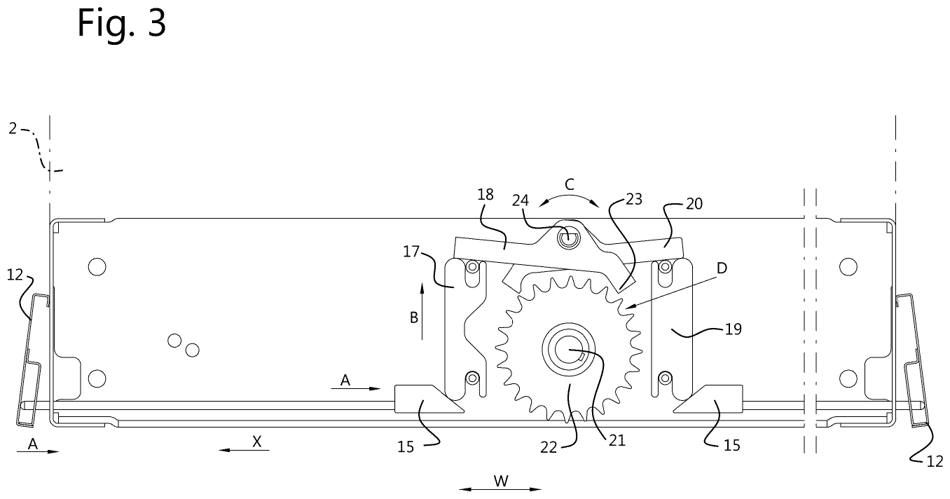

FIG. 3 shows an emergency brake mechanism according to the invention;

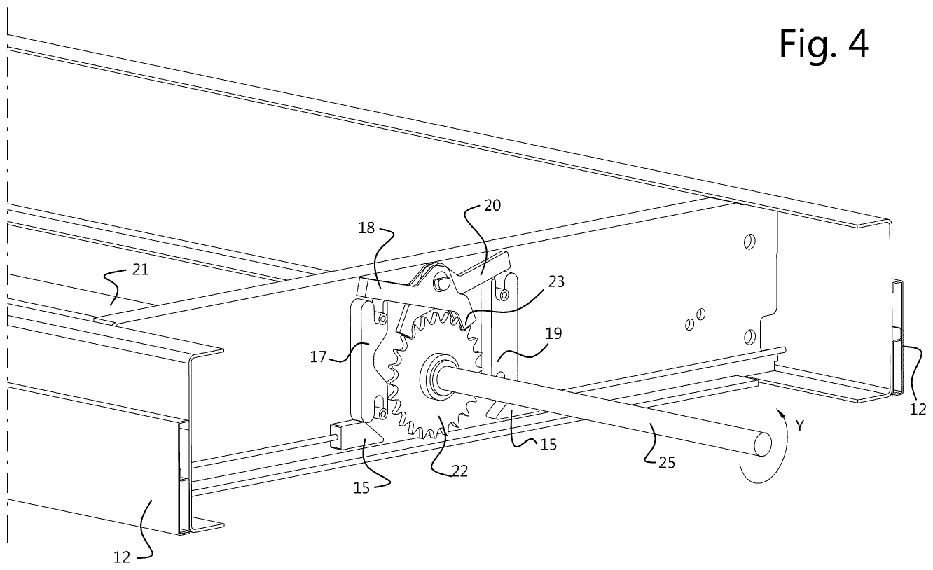

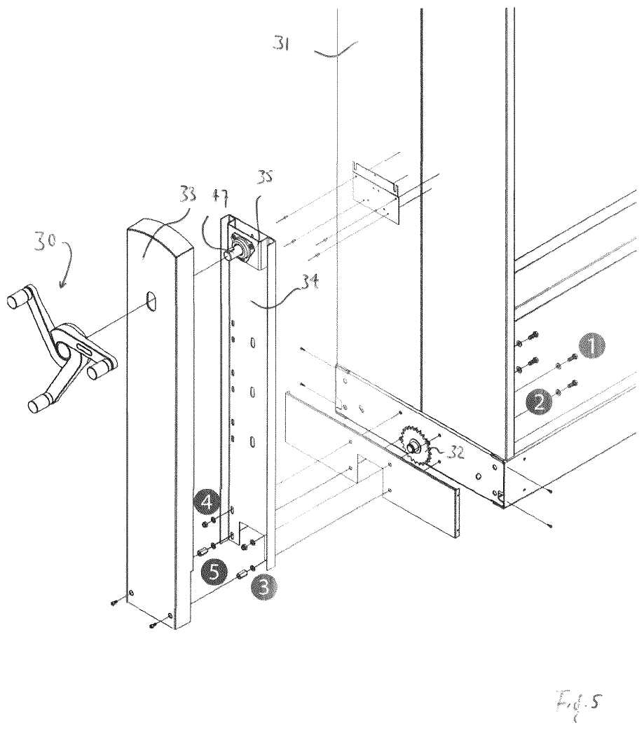

FIG. 4 shows an emergency brake mechanism according to the invention;

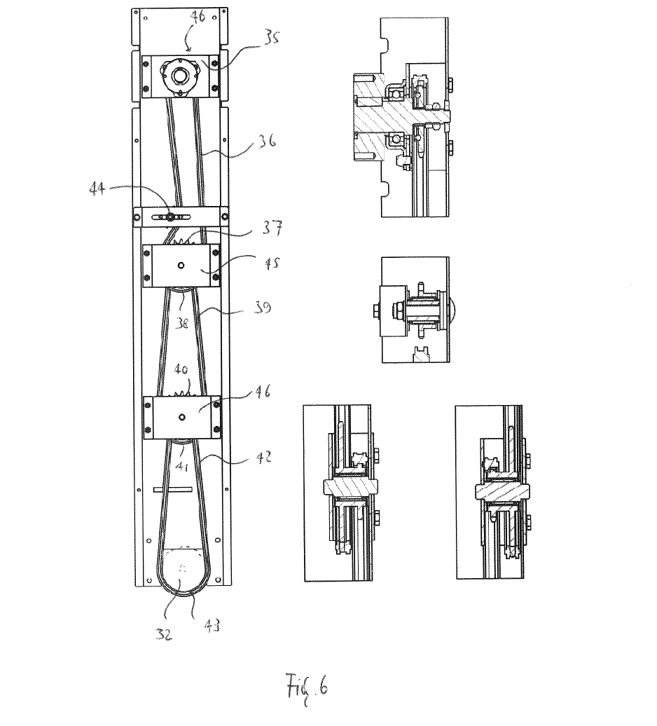

FIG. 5 shows an exploded view of a manual operating element and a transmission;

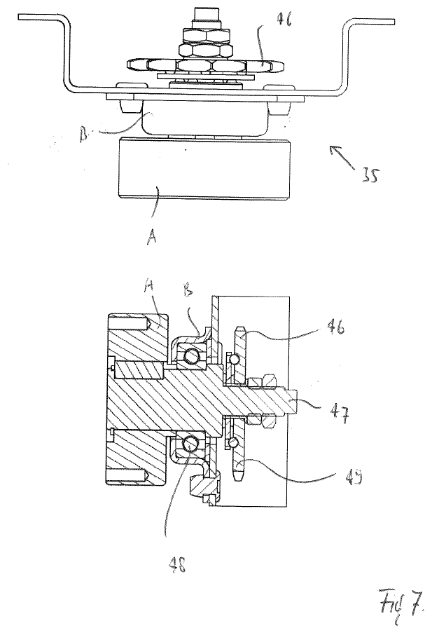

FIG. 6 shows details of a transmission; and

FIG. 7 shows a slip clutch used in the transmission.

FIG. 1 shows a schematic overview of a storage system 1 according to the invention. The system 1 comprises a number of cabinets 2, that each extend in a length direction L and are each movable in a width direction W, perpendicular to the length direction with respect to a support surface 3. In particular, the cabinets 2 are rollable and thereto provided with wheels (5, shown in FIG. 2) that cooperate with a rails 4. The cabinets are each provided with a drive mechanism (6, also shown in FIG. 2) that extends via a transmission between a first engagement point 7 for receiving a driving force or torque, to a second engagement point mechanism (8, also shown in FIG. 2) for exerting a driving force or torque on the surface 3. The second engaging point 8 engages a chain 9 that is embedded in the surface 3. In between two cabinets 2 an aisle 10 is created, which allows to access the contents of the cabinets 2.

FIG. 2 shows a schematic overview of an emergency braking facility 11 of a storage system according to the invention. The figure shows rails 4 on which a cabinet 2 is movable with wheels 5, wherein the cabinet 2 is provided with an emergency braking facility, comprising two activating members 12, each formed by a plinth arranged at one side of the cabinet 2 in the width direction W, which emergency braking facility is adapted to stop the cabinet 2 to a standstill with a limited braking torque or with a limited braking force when the activating member 12 in the direction it is moving to is enabled. The emergency braking facility is adapted to block the drive mechanism 6 at a blocking point 13 located between the first 7 and the second engagement point 8, wherein a force or torque limiter, such as a slip clutch 14, is present between the blocking point 13 and the second engagement point 8.

Both activating members 12 comprise a pressure sensor 12 connected to the cabinet 2, formed by a movable plinth 12 of said cabinet, and coupled to a cam 15 or hook, adapted to (indirectly) engage in an enabled position on teeth of a gear 16 (shown in more detail in FIG. 3), arranged on or coupled to the transmission 6, for forming a blocking.

FIG. 3 shows a detailed view of an emergency brake mechanism according to the invention. The mechanism comprises a plinth 12 ad each side in the width direction W, extending along the bottom (as a plinth does) of the cabinet 2 in the length direction L. Each of the plinths 12 can be pushed in an inward (width W) direction of the cabinet, and is coupled with a cam 15, that is pushed inwardly when the plinth is pushed. In this case, the cams 15 indirectly cooperate with the gear 22. However, embodiments wherein the cams 15 cooperate directly with the gear 22 are also thinkable according to the invention.

The cams 15 are tapered and when a corresponding plinth 12 is pushed (in case of the leftmost plinth 12 because it hits an obstacle such as a person or an object when being moved in direction X), the leftmost cam 15 is moved in the direction A. It then forces a slider 17 to move upward in a direction B. The slider 17 in its turn tilts a lever 18 in a direction C about a point of rotation 24 so that a pin 23 moves in the direction D and blocks the gear 22. The gear 22 is fixed to a shaft 21 so that blocking the gear 22 results in blocking the shaft 21. The shaft 21 is coupled to first side of a slip clutch 14. The second side of the slip clutch 14 is coupled to a further gear 8 by means of shaft 25. Slip clutch 14 allows the gear 8 to rotate and the cabinet 2 to move when the emergency brake system is enabled because one of the plinths 12 is forced inwardly, as long as the momentum of the cabinet 2 causes a force or torque to exceed a set threshold value. A driving force at the second engagement point 7 is directly blocked and cannot accelerate or drive the cabinet 2 any longer. When the momentum of the cabinet causes the torque on shaft 25 to become lower than the threshold value of the slip clutch 14, the cabinet stops moving.

FIG. 4 shows the emergency brake mechanism from FIG. 3 in its engaged position, due to following the sequence of movements A, B, C, D described in relation to FIG. 3. The pin 23 is positioned in between teeth of gear 22 and therewith locks the gear 22, which in its turn also locks the lever 18. In order to release the gear 22, a driving force or torque has to be applied on the first engaging point 7 and then rotates the gear 22 via shaft 21 against a direction Y. If this is done when the plinth 12 is no longer forced inwardly, the cabinet 2 can be moved further in the direction X.

FIG. 5 shows an exploded view of a manual operating element 30 for a cabinet 31 that is configured to be driven by a gear wheel 32. A transmission to convey a driving force from the manual operating element 30 to the gear wheel 32 is housed in housing 33 comprising frame 34. The manual operating element 30 is couplet to a first transmission part 35.

FIG. 6 shows details of the transmission referred to in FIG. 5. The first transmission part 35 comprises a first gear wheel 46 (visible in FIG. 7) coupled to a first chain, that is also coupled to a second gear wheel 35 forming part of a second transmission part 45. The first gear wheel 46 is smaller and has less teeth than the second gear wheel 37. Said second gear wheel 37 is coupled to a third gear wheel 38, driving a chain 39 coupled to a fourth gear wheel 40. The third gear wheel 37 is smaller and has less teeth than the fourth gear wheel 40. Said fourth gear wheel 40 is coupled to a fifth gear wheel 41, which is coupled by a chain 42 to the sixth gear wheel 32. As the fifth gear wheel 41 is smaller and has less teeth than the sixth gear wheel 32, the transmission acts as a reduction. It is provided with a tensioner 44.

FIG. 7 shows a detail of slip clutch used in the first transmission part 35, comprising a gear wheel 46. The first transmission part 35 comprises a ball bearing 48 housed in a bearing housing B, as well as a drive housing A, comprising a torque limiter 49.

The above embodiments are examples only and do not limit the scope of the invention as defined in the following claims.

1. Storage system, comprising a mobile base for supporting at least one cabinet, that is:
movable and in particular rollable with respect to a support surface, provided with
a drive mechanism that extends via a transmission between
at least a first engagement point for receiving a driving force or torque, to
at least a second engagement point for exerting a driving force or torque on the surface,
wherein the cabinet is provided with:
an emergency braking facility, with at least:
one activating member, which emergency braking facility is
adapted to stop the cabinet to a standstill with a limited braking torque or with a limited braking force when the activating member is enabled, wherein the emergency braking facility is adapted to block the drive mechanism at a blocking point located between the first and the second engagement point, wherein a first force or torque limiter, such as a slip clutch, is present between the blocking point and the second engagement point,
wherein:
the drive mechanism comprises a manual operating element, such as a wheel or a handle at the first engagement point for manually driving the shelving unit further comprises a second force or torque limiter, such as a slip clutch arranged in said transmission for manually driving the shelving unit;
wherein:
the second force or torque limiter, such as a slip clutch in the transmission for manually driving the shelving unit, has a threshold torque above which it starts limiting or slipping, that is lower than a threshold torque of the first force or torque limiter, such as a slip clutch, of the emergency braking facility.

2. System according to claim 1, wherein the force or torque limiter has an adjustable value for the force or torque to which it is limited, wherein the threshold value is determined by a set or measured weight of the shelving unit and/or a load thereof.

3. System according to claim 1, wherein the activating member comprises a pressure sensor connected to the cabinet, for instance formed by or coupled to a plinth of said cabinet, comprising a cam or hook, adapted to engage in an enabled position on a slot, recess or teeth, arranged on or coupled to the transmission, for forming a blocking.

4. System according to claim 1, wherein the cabinet is provided with at least two activating members, arranged on either side in width direction of the cabinet, each adapted to block the drive of the cabinet when the activating member is activated on their respective side.

5. System according to claim 1, wherein the emergency braking facility is adapted to anchor the drive mechanism as long as it is not driven in an opposite direction to the direction in which it was blocked.

6. System according to claim 1, wherein a reduction gearbox is located between the blocking point and the first engagement point, for reducing the number of revolutions of a drive movement from the first engagement point to the blocking point.

7. System according to claim 1, wherein a manual operating element is present at the first engagement point, for manually driving the shelving unit.

8. System according to claim 1, wherein the second engagement point comprises a slip-less coupling such as a gear wheel adapted to engage on a chain arranged in or on the support surface.

9. System according to claim 1, comprising a plurality of shelving units that are movable relative to the support surface and in particular rollable, wherein the shelving units are movable over a common rail system.
